(19) United States
(12) Patent Application Publication
(10) Pub. No.: US 2002/0138622 A1
(43) Pub. Date: Sep. 26, 2002

(54) Apparatus and method of using long lived addresses in a private network for push messaging to mobile devices

(75) Inventors: Jheroen P. Dorenbosch, Paradise, TX (US); Cindy J. Viola, Tempe, AZ (US); Brian A. Hansche, Gilbert, AZ (US)

Correspondence Address: MOTOROLA INC, 600 NORTH US HIGHWAY 45, LIBERTYVILLE, IL, 60048-5343, US

(73) Assignee: MOTOROLA, INC.

(21) Appl. No.: 09/813,706

(22) Filed: Mar. 21, 2001

(51) Int. Cl. G06F 15/16

(52) U.S. Cl. 709/227; 709/230

(57) ABSTRACT

A method and system for supporting Internet Protocol (IP) services initiated through a public network, the services directed to a mobile device through a private network is disclosed. In operation these steps occur: assigning a long lived IP address and user name to the mobile in a wireless network; providing a server including a database that cross references the user name and the long lived IP address; connecting an address space for the private network to the public network using a network address translator (NAT); initiating a push session between a push client and the mobile by forwarding from the push client to the server the user name; retrieving and returning to the NAT the long lived IP address corresponding to the user name; and assigning a corresponding dynamic public address, using an ALG that is associated with the NAT and returning the dynamic public address to the push client.

### FIELD OF THE INVENTION

The present invention concerns connecting a private network to a public network and more specifically doing so in a fashion that facilitates push sessions originating in the public network with a mobile device through the private network.

### BACKGROUND OF THE INVENTION

Public and private internet protocol (IP) networks are known. Among other attributes a network may be viewed as a collection of pathways, routers, switches, etc. that allow and provide for a multiplicity of terminating units using a common protocol to unambiguously connect with or to each other. An example of a public network is the network commonly known as the Internet. This public network now utilizes IP version 4 as the common protocol. This protocol has a limited address space and thus a limited number of units with an address that can be unambiguously resolved at any one time. Addresses that fall within this public network address space are referred to as public addresses. Addresses are said to fall or lie or be within an address space if they are within the set of valid addresses for that space.

One known approach for avoiding the limited number of addresses problem has been to establish a private network with a private address space and private addresses falling within this space. Various carriers or organizations have established private networks recognizing that any one unit or terminating unit is unlikely to want or need to set up a session with most of the other units on the Internet. The drawback with this approach is that the private addresses can not be unambiguously resolved by a unit within the public network or Internet because they may be duplicated by other units in other private networks. Thus without more information, units within the public network are unable to contact units within the private network.

The search for a solution to these or this problem has resulted in the concept of a dynamic public address. With this approach a private network is supplied with or allowed to use a small, relative to the population of units within the network, number of public addresses. Using network address translation at the boundary between the private and public networks one of these public addresses can be dynamically associated with a private address thus allowing an external host or client to establish a session with a unit within the private network. The number of such sessions for a particular private network is limited by the number of available dynamic public addresses. Also the persistence or longevity of the session is likewise limited if all or a large number of the units within the private network routinely need even limited access to the public network since the available public addresses will have to be dynamically recycled.

It is generally recognized that wireless push sessions are more efficient when the sessions are between end points with a persistent or stable or resilient or long lasting packet data protocol (PDP) context or where such a context may be easily maintained or quickly established or re-established. For these reasons such sessions are more efficiently implemented when the target unit and the push client have IP addresses within the same address space. Since many push clients are on the public networks it is preferable that the target unit likewise have a public address.

For the same or similar reasons the target unit's IP address should always be reachable. Thus the target unit must either always maintain an active (PDP) context using a dynamic IP address or have a static or long lived address. Unfortunately for the reasons noted above it is not possible for each active device or unit to have a dedicated public address. Industry standards specify or define IP connections or PDP contexts supported over wireless channels to be non-persistent in part due to the perceived ephemeral nature of these connections and the perceived adverse impact on system capacity that may occur with a more persistent connection or context.

What is needed are methods and systems that allow and provide for the efficient delivery of services initiated through a public network and directed to a mobile device through a private network, such as the services that may be expected from a push client.

### BRIEF DESCRIPTION OF THE DRAWINGS

The accompanying figures, where like reference numerals refer to identical or functionally-similar elements throughout the separate views and which are incorporated in and form part of the specification, further illustrate various embodiments in accordance with the present invention. The figures together with the detailed description, hereinafter below, serve to explain various principles and advantages in accordance with the present invention. The present invention however is defined solely by the appended claims.

FIG. 1 depicts, in a simplified and representative form, a block diagram of an overall system including a private network in accordance with the present invention;

FIG. 2 depicts an exemplary diagram of a data packet that would be expected to be encountered in the system of FIG. 1; and

FIG. 3 depicts a process flow chart of a method of supporting IP services for a mobile device that are initiated through a public network in accordance with the present invention.

### DETAILED DESCRIPTION OF A PREFERRED EMBODIMENT

In overview form the present disclosure concerns methods and private networks for supporting Internet Protocol (IP) based services, such as push services, that have been initiated within or through a public network. The services are directed to a mobile device through a private network. The methods and private networks of particular interest are those utilizing internet protocol (IP) to provide services to a mobile device or mobile station such as a cell phone or the like using a radio access network. As further discussed below various inventive principles and combinations thereof are advantageously employed to effectively and efficiently provide services to mobile devices operating on such networks provided these principles or equivalents are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use, if any, of relational terms such as first and second, top and bottom, and the like are used solely to distinguish one from another entity or action without necessarily requiring or implying any actual such relationship or order between such entities or actions. Much of the inventive functionality and many of the inventive principles are best implemented with, in, or through software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore further discussion of such software, if any, will be limited in the interest of brevity and minimization of any risk of obscuring the principles and concepts in accordance with the present invention.

The present disclosure will discuss various embodiments in accordance with the invention. These embodiments include methods, servers, address translators, radio access networks, mobile devices, etc and private networks employing each or all of the aforesaid. The system diagram of FIG. 1 will be used to lay the groundwork for a deeper understanding of the present invention and advantages thereof. FIG. 1 in large part and at the simplified level depicted is a representative diagram of an extended communications system 100 suitable for using IP protocols to provide connections amongst the various entities depicted. It is expected that this system will serve to explain various problems and certain inventive solutions thereto according to the present invention.

FIG. 1 depicts a public network 101, specifically the Internet, including or coupled to a multiplicity of push servers, specifically a push server or client 103. The public network uses IP protocols, such as TCP/IP and public addresses to communicate between the push client(s) or other hosts or units that are connected to or part of the public network (not specifically depicted). The push server or client operates to initiate the transfer of or push data over or through the public or external network to target devices or consumers of the data.

The public network is also coupled to a private network 105 by way of a network address translator (NAT) 107. The NAT operates to assign a public address or dynamic public address to a corresponding private address within the private network and to translate between the two as data packets are exchanged between the networks. The NAT 107 includes an associated application layer gateway (ALG) 109, normally implemented as a software program that provides a similar but application dependent address translation within the payload portion of a data packet.

The private network 105 further includes a server 111 which has a database that cross references static or long lived IP addresses 113 that fall within the private network's address space and corresponding user names 115. The addresses and user names are uniquely assigned as associated pairs to mobile devices, such as mobile device 117. There will be a unique private and long lived IP address and corresponding user name for each mobile device within or served by or through the private network. This long lived IP address will normally represent the mobile device or accessory equipment associated with the mobile device such as a laptop computer coupled through the mobile device. Normally the name will represent the mobile device or associated equipment but may as well represent the end user of the device. The database can be populated with addresses and user names in various manners. For example they may be programmed by the system operator when the server is a domain name server or a wireless application server or the mobile device can supply the information (addresses and name) whenever it attaches to the radio access network (see below) and when the server is a service initiation protocol server each as further explained below.

Additionally included in the private network or within the private networks address space is a radio network or radio access network (RAN) 119 preferably comprised of one or more Gateway GPRS Support Nodes (GGSN)s 121 (one depicted), at least one of which is coupled to and communicates with a home location register (HLR) 123 which is typically a separate system entity. The radio access network is generally known and operates in a scheduled fashion with transceivers to provide radio wave based communications paths 127 between the RAN and the mobile device 117 that operate on or over or through the RAN. Examples of such RANs include the General Packet Radio Service (GPRS), General Specialized Mobile (GSM), PCS, and other cellular systems as well as various next generation (2.5G, 3G) systems being proposed such as EDGE, UMTS, or CDMA 2000. It is expected that the present concepts would further be applicable to various wireless local area networks such as Bluetooth, IEEE 802.11b, etc. In addition to the radio access techniques these concepts are equally applicable to most access technologies for mobile devices, including for example free space optical networks or fixed line networks that support mobile devices. The mobile device's memory 125 or possibly associated equipment (generally referred to hereinafter collectively as the mobile device) is preferably programmed with the long lived IP address or the user name associated with the mobile device. Likewise the HLR is programmed with the long lived address or corresponding user name for each mobile device of interest to the RAN 119.

The private network 105 of FIG. 1 is arranged and constructed to support Internet Protocol (IP) based services, such as those from the push client 103, that are initiated over or through or within the public network 101 and directed to the mobile device 117 through the private network. The private network as noted above includes the server 111. This server has an IP address within or mapped to a zone of the private network that is accessible from the public network. The server as earlier noted includes the database that cross references the user name 115 and the long lived IP address 113 assigned to the mobile device 117. The long lived IP address is a private address that falls within the zone or portion of the address space of the private network and may be expected to change infrequently, if ever. The long lived address thus maps the mobile device to the zone. The particular form of the server will depend on the choice of the private network operator or his customers and may be either a Session Initiation Protocol (SIP) registrar server, Wireless Application Protocol (WAP) server, or Domain Name Service (DNS) server.

The network address translator (NAT) 107 is coupled to the server 111 over the private network 105 and is suitable, arranged, and constructed for connecting or coupling an address space within the private network that corresponds to the zone to the public network using address translation. Upon session initiation the NAT will receive the user name, for example, in the form of a Universal Resource Locator (URL) xxx@privatenet.com, from a push client and forward the user name xxx or the URL to the server. The application level gateway (ALG) 109 that is associated with the NAT, receives the long lived IP address from the server as, for example, the server responds to the forwarding of the user name. The ALG assigns a corresponding dynamic public address which the NAT returns to the push client. The push client is now enabled and can provide content directly to the mobile device having the long lived IP address using the dynamic public address and the address translations. The ALG will vary in form and function with the specifics of the push protocol being used and thus may be SIP ALG, WAP ALG, DNS ALG, etc. each arranged to perform additional translation activities within the payload portion of the IP data packets.

While the mobile device by virtue of the long lived and private address is effectively mapped to the private network this is accomplished, for example and in this instance, by using a RAN 119, with the GGSN 121, preferably, including the HLR 123 that includes the long lived IP address. The RAN facilitates establishing a PDP context using the long lived IP address between the mobile device and the GGSN or RAN. Note the mobile or associated accessory equipment will be programmed with and thus uniquely identified within the private network by the long lived IP address.

A PDP context, essentially an IP connection including various associated parameters such as data rates, security, etc., can be established using standard RAN procedures by an activation procedure that is initiated by the mobile device. The mobile device may further be programmed to de-activate the context as soon as it is no longer needed typically by an application running on the device. For example the mobile device 117 may activate a context when the end-user starts to retrieve or send email and deactivate the context if all email has been read or sent. Alternatively the mobile device may be programmed to keep an active context for a longer time, for example, so long as it is powered up.

By assigning a static address to the mobile, a standard RAN procedure further allows units in the private network to request the establishment of a PDP context and thus to create an IP connection. The procedure, known as Network Requested PDP Context Activation (NRCA), is typically triggered by sending a data packet to the gateway 121 of the RAN 119 using the static IP address of the target mobile device. The Gateway will then collaborate with RAN entities, such as the mobile device and the HLR, to activate the PDP context and to deliver the data packet.

Note that the assignment of a static address thus enables a push server or client that is inside the private network 105 (not shown) to push data packets to the mobile device by sending the packets to the gateway 121 on the IP address of the target MS. If an active context exists at the time the gateway 121 receives the packet, the gateway 121 will push the packet to the target mobile device over that context. If there is no context at the time of reception the gateway will execute the NRCA procedure to activate a new context and push the packet to the mobile device over the new context. However, without the use of this invention a push server or client on the public network 101 will not be able to push packets to the mobile device since they would not be able to use the long lived address of the mobile on the public network.

When the protocol being used to start the push session is SIP, the server 111 in the private network 105 is a SIP registrar server. The SIP protocol is described in IETF rfc 2543. The SIP registrar database keeps track of where a session target, identified by SIP URL user name, can be contacted. This information is stored in the form of a ‘Contact’. For a mobile device the Contact contains the device's long lived IP address from the private address space.

SIP session initiation involves the exchange of a set of messages between the push server or client, the SIP registrar, and the mobile device. The messages will establish such necessary details as authentication; authorization; the encoding mechanism for the pushed data; and the IP addresses that will be used by the push server or client and the mobile device for reception of data during the session. The push server or client sends the first message of the exchange. It is an INVITE message that contains the SIP URL or user name of the target mobile device. As per SIP protocol rules, the INVITE is routed to the SIP registrar server; it will traverse the NAT. The SIP registrar server will then retrieve from its database the Contact for the mobile device associated with the user name, and thus obtain the IP address assigned to the mobile device. At this point the SIP protocol allows for various ways for the registrar to handle the INVITE. In one variation, called ‘forwarding’, the registrar forwards the INVITE to the mobile device, in another one, called ‘redirection’ it returns the Contact information to the originator of the INVITE. Both variations are described below.

In the forwarding case, the SIP registrar server forwards the INVITE message to the information obtained from the Contact: the mobile device's static, long lived IP address. When the message reaches the gateway 121, the gateway will execute the NRCA procedure discussed above, if needed to create an IP connection and send the message to the mobile device. The mobile device will send a response message to the push server or client. The response contains the IP address and possibly the IP port on which it wants to receive any data for the session. The IP address will be the device's long lived IP address from the private address space.

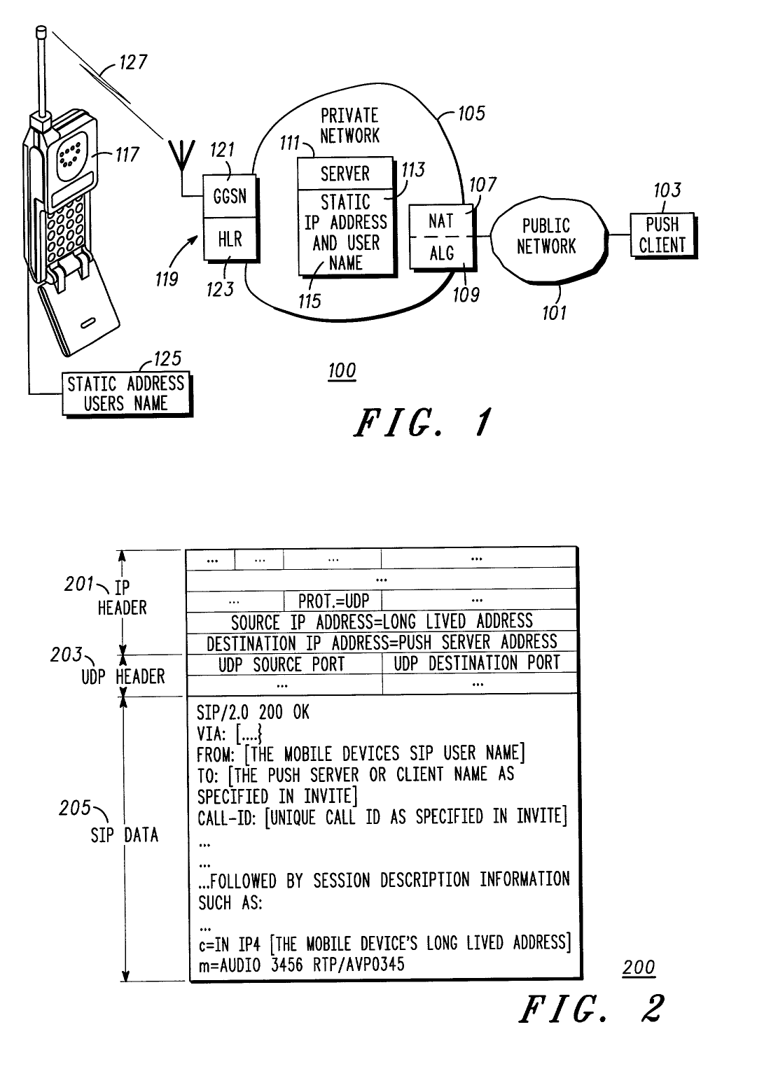

Referring to FIG. 2 a typical SIP response data packet 200 is depicted. This packet includes an IP header 201, a UDP header 203 and a SIP message body or SIP data 205. The IP header contains the IP addresses of the source and destination; a field that indicates that the UDP protocol is used; and other fields normally present in the IP header, but irrelevant to this disclosure. What is relevant here is that the device will specify its long lived private IP address as the Source IP Address. SIP can use UDP as well as TCP. FIG. 2 shows the more common use of UDP. The UDP header contains the IP port numbers of the source and destination. The SIP message body contains such information as the SIP protocol version (2.0) and the SIP message type (200 OK); the user names of source and destination; a unique session identifier or Call-ID; and instructions where and how to send data for the session. In this case the device specifies it will accept audio data sent to it using the RTP protocol on the IP address specified in the line starting with ‘c=’. What is relevant here is that the SIP message body contains the value of the device's private long lived address.

Continuing the SIP ‘forwarding’ case: on its way to the push server or client, the response data packet will return to the NAT. NAT will assign a dynamic public address corresponding to the long lived IP address. It will store the relationship between the addresses. NAT is aware of the format of IP, TCP and UDP headers and substitutes an assigned dynamic public address for the long lived IP source address. Optionally NAT may also assign a dynamic port address and substitute it for the source IP port number. However, NAT is not aware of the format of the SIP message body. Hence NAT will invoke the help of a SIP application level gateway (SIP ALG) 109. The SIP ALG will identify, in the SIP message body, IP addresses and port numbers that need to be substituted, and provide a substitution with the dynamic public address and port number assigned by NAT. In the typical SIP response packet depicted in FIG. 2, the NAT will substitute the device's long lived IP address in the Source IP Address field with the assigned dynamic public address; while the SIP ALG will make the substitution in the line stating with ‘c=’.

After substitution the packet will reach the push server or client. The client can use the address from the ‘c=’ line to push data packets to the mobile device. The packets will travel via the NAT 107 and the GGSN 119 to the mobile device 117. The NAT will substitute the device's dynamic address with the device's private long lived address using the stored relationship. The GGSN will forward the packet to the mobile device on the existing context.

As is mentioned above, in the case of redirection, the SIP registrar server 111 returns the contact information to the originator of the INVITE message. It does so by sending a SIP redirection message to the push server or client 103. Since the mobile device is neither the source nor the destination of the message, the message does not contain the mobile device's IP address in the IP header 201 or UDP header 203. However, the SIP message body 205 of the redirection message contains the ‘Contact’ information for the mobile device in the form of the device's long lived address. On its way to the push server or client the message will pass the NAT 107. NAT itself does not translate the device's address, but NAT detects the presence of the SIP message body and invokes the help of a SIP application level gateway (SIP ALG) 109. The SIP ALG will identify IP addresses and port numbers that need to be substituted, request the NAT to provide a dynamic address and optional port number for the mobile device, and provide substitution with the dynamic public address and port number assigned by the NAT. The push server or client 103 thus obtains contact information for to the mobile device. As per SIP protocol, the push server or client 103 will again send the SIP INVITE message; this time to the destination IP address obtained from the contact information. This destination IP address is the dynamic public IP address assigned by the NAT. The INVITE message will reach the NAT. The NAT will substitute the destination IP address with the private long lived address of the mobile device and forward the INVITE message. When the INVITE message reaches the gateway 121, the gateway will execute the NRCA procedure, discussed above, if needed, to create an IP connection and send the message to the mobile device. The mobile will send a response message like the message depicted in FIG. 2. From there on the session will continue. The NAT in collaboration with the SIP ALG will continue to substitute private long lived address and dynamic public address as required for the session. The SIP ALG may detect the termination of the session and collaborate with the NAT to release the assigned dynamic public address.

When the protocol used to start the push session is DNS, the server 111 in the private network 105 is a Domain Name Server. The DNS protocol is described in IETF rfc 2065. The DNS server's database keeps the correspondence between a mobile device's user name and the device's long lived IP address from the private address space. In this case the push server or client 103 starts or initiates the session by sending a DNS query message for the IP address corresponding to the user name of the mobile device. The DNS query message will travel through the public network 101, the NAT 107 and the private network 105 to reach the DNS server 111. The DNS server will access its database, retrieve the mobile devices long lived address, insert the address into the DNS message body of a response DNS message; and send the response DNS message to the originator of the query. On its way to the push server or client, the response DNS message will hit the NAT 107. Again, neither the IP header nor the UPD header contain the mobile device's address, so NAT does not substitute it. NAT, however, does detect the presence of the DNS message body and invokes the help of a DNS application level gateway (DNS ALG) 109. The DNS ALG is described in rfc 2694. The DNS ALG will identify IP addresses and port numbers that need to be substituted, request NAT to provide a dynamic address and optional port number for the mobile device, and provide substitution with the dynamic public address and port number assigned by NAT. The push server or client 103 thus obtains IP address information for to the mobile device and can continue the session and send one or more IP data packets to the mobile device, using the dynamic address as the destination IP address. From there on the session will continue. The NAT 107 will continue to substitute private long lived address and dynamic public address as requested by the session. When a packet reaches the gateway 121, the gateway will execute the NRCA procedure, if needed to create an IP connection, and send the packet to the mobile device.

When the protocol being used to start the push session is WAP, the server 111 in the private network 105 is a WAP server. The WAP server's database keeps the correspondence between a mobile device's user name and the device's long lived IP address from the private address space. In this case the push server or client 103 starts the session by sending a WAP message to the WAP server. The WAP message will reach the WAP server 111. Currently WAP does not define a method whereby the WAP server returns an IP address to a push server or client. However, such functionality may soon be added. In this case the WAP server would access its database, retrieve the mobile devices long lived address, insert the address into the WAP message body of a response WAP message; and send the response to the push server or client 103. The NAT 107 will have to invoke the help of a WAP application level gateway (WAP ALG) 109. The WAP ALG will identify IP addresses and port numbers that need to be substituted, request NAT to provide a dynamic address and optional port number for the mobile device, and provide substitution with the dynamic public address and port number assigned by NAT. The push server or client 103 thus obtains IP address information for the mobile device and can continue the session and send one or more IP data packets to the mobile device, using the dynamic address as the destination IP address. From there on the session will continue as discussed above with respect to the DNS case.

It will be appreciated that the push server or client 103 may be located in a further private network, different from the private network 105. This further private network would be connected to the public network 101 via a second NAT, the second NAT collaborating with a second ALG. In this instance address and optional port translations would occur in both NATs, the operation of the NAT 107 remains identical or similar to that described above.

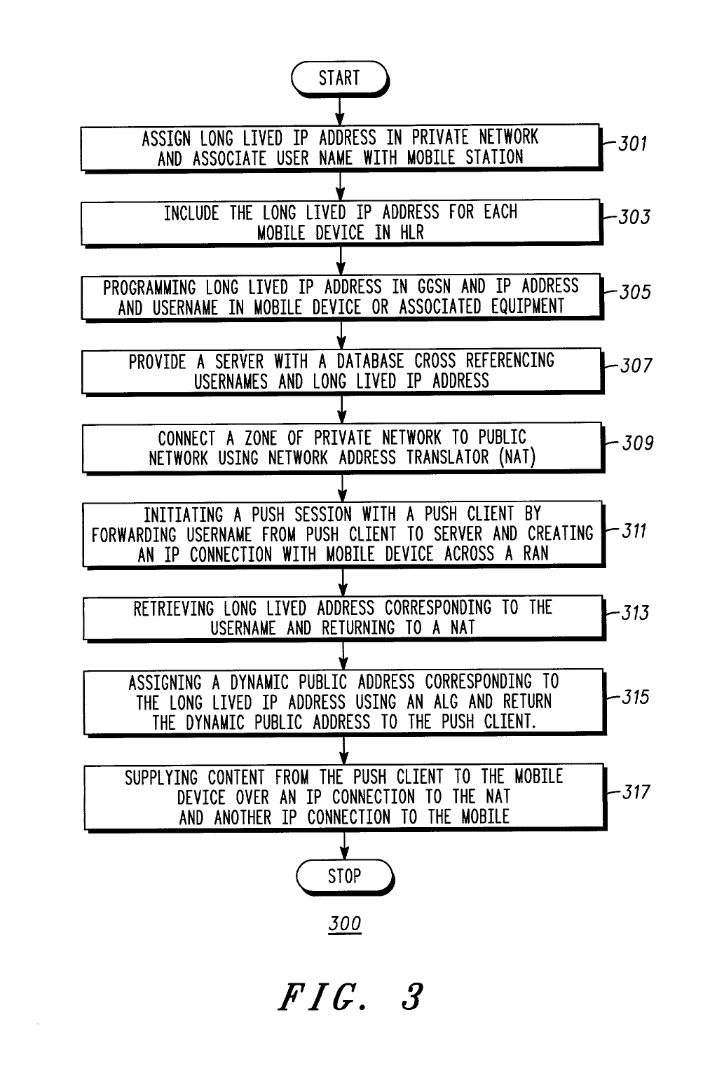

From the perspective of a method FIG. 3 will now be described. FIG. 3 depicts a process flow chart of a method 300 of supporting IP services for a mobile device that are initiated through a public network in accordance with the present invention. Such IP based services are directed to a mobile device through a private network. The method 300 starts and at step 301 assigning a long lived IP address to and associating a user name with the mobile device in a wireless network is undertaken. This results in a mapping of the mobile device to a zone of a private IP network. Step 303 and 305 respectively denote including the long lived IP address for mobile stations in a home location register (HLR) and optionally programming that corresponding information into a memory of the mobile device or associated equipment and GGSN. This optional programming may serve to speed up context activation and otherwise result in more robust operation.

Step 307 indicates providing a server having an IP address within the zone and including a database having a cross reference between the user name and the long lived IP address for the mobile station. This server can be a SIP registrar server, WAP server, or DNS server as explained above. At step 309 connecting an address space of the zone to the public network using a network address translator (NAT) is indicated.

Then step 311 is devoted to initiating a push session between a push client and the mobile station by forwarding from the push client to the server the user name and creating an IP connection via a RAN with the mobile device using the long lived address. Next, step 313 provides for retrieving and returning to the NAT the long lived IP address corresponding to the user name. At step 315 assigning a dynamic public address that corresponds to the long lived IP address, thus the mobile device, using an application level gateway (ALG) that is associated with the NAT and returning the dynamic public address to the push client is depicted. Note is may be preferred to delay the creation of the connection with the mobile device until the data from the following step 317 is sent to the target mobile device. Step 317 shows supplying content or push data from the push client to the mobile device using an IP connection, including said dynamic public address, between the push client and the NAT and another IP connection, including the long lived IP address, between the NAT and the mobile device.

It will be appreciated that while push services can now be delivered more or less transparently by a push server or client 103 over the public network, the NAT 107 will introduce a finite delay in the delivery of the push content. In contrast, a push server or client (not shown) installed in the private network 105 will not experience NAT-associated delays in push content delivery. Moreover, the system operator can limit or selectively limit the performance of the NAT, the ALGs installed at the NAT or the functionality of the NAT, ALGs, or servers to consciously create a larger difference in performance and functionality for push servers or clients inside the private network 105 when compared to push servers or clients 103 on the public network 101. For example an artificial delay could be added to any of these network entities or certain addresses could be blocked or partially blocked based on the address, the content, etc that was being provided by the external push client. In one form or another the private network operator can provide preferential access to the mobiles for push servers or clients inside the network. The operator can then derive economic benefit (income) from allowing third parties to deliver high quality push services from push servers or clients inside the private network.

Various embodiments of IP based communications systems that provide for push services, originating in or through or over public networks, that are directed to mobile devices in, over, or through private networks have been discussed and described. The disclosure extends to the constituent elements or equipment comprising such systems and the methods employed thereby and therein. Using the inventive principles and concepts disclosed herein advantageously allows or provides for efficiently and effectively providing push services to mobile devices and users thereof. This disclosure is intended to explain how to fashion and use various embodiments in accordance with the invention rather than to limit the true and intended scope and spirit thereof. The invention is defined solely by the appended claims, as may be amended during the pendency of this application for patent, and all equivalents thereof.

What is claimed is:

1. A method of supporting Internet Protocol (IP) based services initiated through a public network, the services directed to a mobile device through a private network, the method including the steps of:
assigning a long lived IP address and a user name to the mobile device in a wireless network; the long lived address mapping the mobile device to a zone of the private network;
providing a server having an IP address within said zone and including a database having a cross reference between said user name and said long lived IP address for said mobile station;
connecting an address space of said zone to the public network using a network address translator (NAT);
initiating a push session between a push client and the mobile device by forwarding from said push client to said server said user name;
retrieving and returning to said NAT said long lived IP address corresponding to said user name; and
assigning a dynamic public address that corresponds to said long lived IP address, thus the mobile device, using an application level gateway that is associated with said NAT and returning said dynamic public address to said push client.

2. The method of claim 1 wherein said step of assigning a long lived IP address further includes including said long lived IP address in a home location register database within a radio network.

3. The method of claim 1 wherein said step of assigning a long lived IP address further includes programming said long lived IP address into the mobile device.

4. The method of claim 1 wherein said step of initiating a push session further includes creating an IP connection across a radio access network between the mobile station and the private network.

5. The method of claim 1 wherein said step of providing a server includes providing a session initiation protocol (SIP) registrar server.

6. The method of claim 1 wherein said step of providing a server includes providing a domain name service (DNS) server.

7. The method of claim 1 wherein said step of providing a server includes providing wireless application protocol (WAP) server.

8. The method of claim 1 wherein said step of assigning a dynamic public address using an application level gateway (ALG) includes using one of a SIP ALG, DNS ALG, and WAP ALG.

9. The method of claim 1 further including a step of supplying content from the push client to the mobile device using an IP connection, including said dynamic public address, between the push client and the NAT and another IP connection, including the long lived IP address, between the NAT and the mobile device.

10. A private network that is arranged and constructed to support Internet Protocol (IP) based services initiated through a public network, the services directed to a mobile device through the private network, the private network including in combination:
a server having an IP address within a zone of the private network that is accessible from the public network, the server including a database having a cross reference between a user name and a long lived IP address assigned to the mobile device, said long lived address mapping the mobile device to said zone;
a network address translator (NAT), coupled to said server, suitable for connecting an address space corresponding to said zone to the public network using address translation, said NAT receiving said user name from a push client and forwarding said user name to said server; and
an application level gateway that is associated with said NAT and that, responsive to said forwarding said user name, receives said long lived IP address from one of said server and the mobile device and assigns a corresponding dynamic public address which is returned to said push client, thereby enabling said push client to provide content to the mobile device having a long lived IP address.

11. The private network of claim 10 further including a radio access network with a home location register that includes said long lived IP address and facilitates establishing a long lived IP context between the mobile device and said radio access network.

12. The private network of claim 10 wherein the mobile is programmed with and thus uniquely identified within said private network by said long lived IP address.

13. The private network of claim 10 wherein said server is a session initiation protocol (SIP) registrar server.

14. The private network of claim 10 wherein said server is a domain name service (DNS) server.

15. The private network of claim 10 wherein said server is a wireless application protocol (WAP) server.

16. The private network of claim 10 wherein said application level gateway (ALG) is one of a SIP ALG, DNS ALG, and WAP ALG.

17. A private network that is arranged and constructed to support Internet Protocol (IP) based services initiated through a public or private network, the services directed to a mobile device through the private network, the private network including in combination:
a server having an IP address within a zone of the private network that is accessible from the public network, the server including a database having a cross reference between a user name and a long lived IP address assigned to the mobile device, said long lived address mapping the mobile device to said zone;
a network address translator (NAT), coupled to said server, suitable for connecting an address space corresponding to said zone to the public network using address translation, said NAT receiving said user name from a push client and forwarding said user name to said server;
an application level gateway that is associated with said NAT and that, responsive to said forwarding said user name, receives said long lived IP address from one of said server and the mobile device and assigns a corresponding dynamic public address which is returned to said push client, thereby enabling said push client to provide content to the mobile device having a long lived IP address; and
a second push client with an address inside the private network arranged and constructed to push services to the mobile wherein one of said server, said NAT, and said ALG operate to insure preferential access to the mobile from the second push client.
